(19) United States
(12) Patent Application Publication
(10) Pub. No.: US 2024/0253664 A1
(43) Pub. Date: Aug. 1, 2024

(54) DYNAMIC MODIFICATION OF PRE-DEFINED OPERATIONAL PLAN FOR AUTONOMOUS VEHICLE

(71) Applicant: GM Cruise Holdings LLC, San Francisco, CA (US)

(72) Inventor: Honglu Zhang, Fremont, CA (US)

(73) Assignee: GM Cruise Holdings LLC, San Francisco, CA (US)

(21) Appl. No.: 18/160,050

(22) Filed: Jan. 26, 2023

(51) Int. Cl. B60W 60/00; B60W 40/02

(52) U.S. Cl. CPC B60W 60/0015; B60W 40/02; B60W 2050/0075; B60W 2556/45

(57) ABSTRACT

An AV can dynamically modify an operational plan received from an online system based on information specific to an operation of the AV. The operational plan includes a limit on the AV's operation. The information may indicate a condition of an environment detected by a sensor suite of the AV or another AV, a preference of a user receiving a service provided by the AV through the operation, or a capability of one or more components of the AV. The information may include historical performance of the AV under the same environmental condition(s). The AV may determine that there is a safety risk to operate within the limit and can modify the limit to reduce the safety risk. Alternatively, the AV may determine that there is no safety risk to operate beyond the limit and can extend the limit. The AV may use a trained model to modify the limit.

### TECHNICAL FIELD OF THE DISCLOSURE

The present disclosure relates generally to autonomous vehicles (AVs) and, more specifically, to dynamic modification of pre-defined operational plans for AVs.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide services to users, according to some embodiments of the present disclosure;

FIG. 2 is a block diagram showing a fleet management system, according to some embodiments of the present disclosure;

FIG. 3 is a block diagram showing a sensor suite, according to some embodiments of the present disclosure;

FIG. 4 is a block diagram showing an onboard computer, according to some embodiments of the present disclosure;

FIG. 5 is a block diagram showing a control module, according to some embodiments of the present disclosure;

FIG. 6 illustrates examples of dynamic modifications of operational plans, according to some embodiments of the present disclosure; and

FIG. 7 is a flowchart showing a method of dynamically modifying a pre-defined operational plan for an AV, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless ride services. A person can request an AV to pick him/her up from a location and drop him/her off at another location. With the autonomous driving features of the AV, the person does not have to drive during the ride and can be a passenger of the AV. The AV can navigate from the pick-up location to the drop-off location with no or little user input. AVs can provide other driverless services too, such as delivery service. A person can request an AV to deliver one or more items from one location to another location, and the person does not have to drive or be a passenger of the AV for the delivery.

Driverless operations of AVs are usually controlled by operational plans provided by a system that manages one or more fleets of AVs that provide services. An example operational plan may be an operational design domain (ODD), which may include a description of the specific operation domain in which an AV is designed to properly operate. An operational plan can specify limitations on AV operations, e.g., AV operations for providing services. Such limitations are also referred to as operational limitations. An operational limitation may be a constraint on an attribute of the AV (e.g., the AV's location, orientation, or other attributes), a movement of the AV (e.g., speed, acceleration, deceleration, acceleration rate, deceleration rate, etc.), an environment where the AV operates (e.g., a geofenced area, weather condition, road condition, etc.), a time when the AV operates (e.g., hours of operation), and so on. The system usually defines an operational plan prior to the operations of the AVs. After receiving the pre-defined operational plan, the AVs will operate in accordance with the pre-defined operational plan. However, since the operational plan is pre-defined, it may not foresee unexpected situations (such as unexpected weather condition, unexpected road condition, unexpected user preference, and so on) that may happen when the AVs operate to provide services.

For example, an AV may provide a service under a weather condition, such as fog, snow, haze, etc., that can interfere with the AV's operation but was not expected by the system when the operational plan was defined. The operational plan may specify a motion limit (e.g., speed limit, acceleration limit, jerk limit, maneuver limit, etc.) that is proper for normal weather conditions. When the AV drives based on the motion limit under the weather condition, the AV may not be able to perform its best performance. As another example, the pre-defined operational plan may include a limitation determined by the system based on a common situation, but the common situation may not occur during the operation of the AV, causing the limitation to unnecessarily impair the efficiency of the AV's operation. As yet another example, the system may define the operational plan before a user requests a driverless ride service by the AV and therefore, the system may not be able to incorporate the user's request, which may indicate one or more preferences of the user for the ride, into the operational plan. Given the drawbacks of AV strictly following pre-defined operational plans, improved technologies for controlling AV operations are needed.

Embodiments of the present disclosure may improve on at least some of the challenges and issues described above by facilitating AVs to dynamically and automatically modify pre-defined operational plans based on information that is specific to the AVs' operations.

In various embodiments of the present disclosure, a fleet management system is in communication with a fleet of AVs that provides one or more services to users of the fleet management system. The fleet management system can generate an operational plan, which is to be used to control operations of the AVs, e.g., operations for providing ride services or delivery services. An AV may receive the operational plan from the fleet management system, e.g., after the fleet management system assigns a service task to the AV. The operational plan includes one or more limitations on the AV's operation to complete the service task. The AV may operate in an environment based on the operational plan. Instead of strictly following the operational plan, the AV can dynamically modify the operational plan based on information obtained during its operation and use the modified operational plan to control its behaviors. The information may indicate a condition of an environment detected by a sensor suite of the AV or another AV, a preference of a user receiving a service provided by the AV through the operation, or a capability of one or more components of the AV.

In some embodiments, the AV may use the information to predict a performance of the AV operating within or beyond a limitation in the operational plan and can adjust the limitation based on the predicted performance. The predicted performance may be a predicted safety risk, a predicted comfort of a passenger (if any) of the AV, or a combination of both. For instance, the AV may determine that there is a safety risk to operate within the limitation and can modify the limitation to reduce the safety risk, so that the operation of the AV can be safer. Alternatively, the AV may determine that there is no safety risk to operate beyond the limitation and can extend the limitation, so that the utilization or efficiency of the AV or the quality of the service can be improved. In some embodiments, the AV may use a model (such as a trained model) to predict the AV's performance. The model may receive the information as an input and output a prediction of the AV's performance. Additionally or alternatively, the AV may use one or more performances of the AV under the same or similar conditions in one or more previous operations to predict the AV's performance in the current operation. Through the dynamic and automatic modification of operational plans, the AVs can maximize their utilization, efficiency, and service quality and can minimize safety risks in their operations.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example System Including AVs

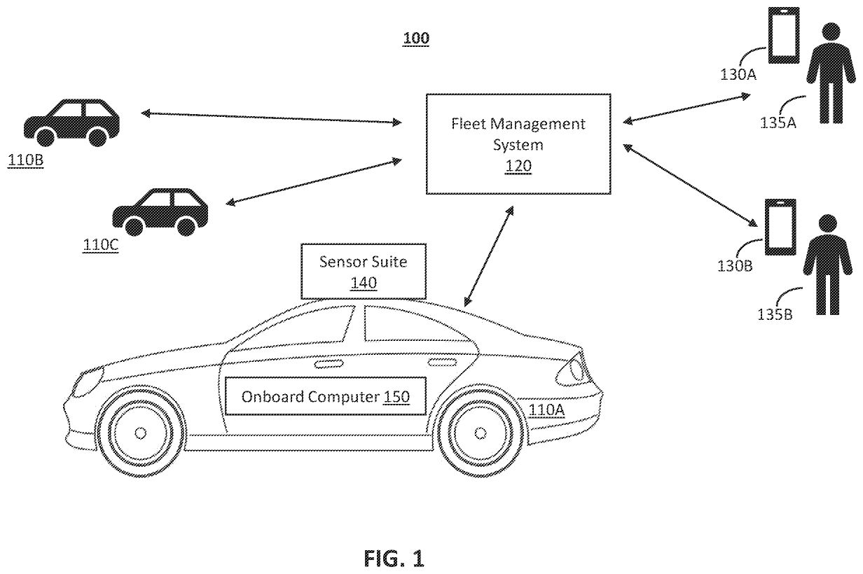

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 135B, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage operations of the AVs 110. In some embodiments, the fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a network, such as the Internet. In some embodiments, the fleet management system 120 may receive service requests for the AVs 110 from the client devices 130. In an example, the user 135A may access an app executing on the client device 130A and requests a ride from a pickup location (e.g., the current location of the client device 130A) to a destination location. The client device 130A may transmit the ride request to the fleet management system 120. The fleet management system 120 may select an AV 110 from the fleet of AVs 110 and dispatches the selected AV 110 to the pickup location to carry out the ride request. In some embodiments, the ride request may further include a number of passengers in the group. In some embodiments, the ride request may indicate whether a user 135 is interested in a shared ride with another user traveling in the same direction or along the same portion of a route. The ride request, or settings previously entered by the user 135, may further indicate whether the user 135 is interested in interaction with another passenger.

The fleet management system 120 may provide an operational plan to an AV 110 for a service task assigned to the AV 110. The operational plan may include information about the service, such as one or more locations associated with the service (e.g., pickup location, drop-off location, etc.), one or more timestamps associated with the service (e.g., pickup time, drop-off time, etc.), information about the user who requested the service (e.g., identification information, user location, user profile, etc.), and so on. The operational plan may also include information about an environment in which the AV 110 will operate to provide the service. The environment may be a real-world region, area, or scene. For instance, the operational plan may include information about one or more conditions in the environment (“environmental conditions”). Examples of environmental conditions include weather condition (e.g., rain, snow, wind, etc.), road condition (e.g., road closures, water accumulation, road grade indicating a rate of change of the road elevation, etc.), traffic condition (e.g., traffic congestion, accidents, etc.), other types of environmental conditions, or some combination thereof. In some embodiments, the operational plan may be an ODD.

The operational plan includes one or more limitations on the operation of the AV 110 for providing the service. Example limitations include limitation on an attribute of the AV 110, limitation on a movement of the AV 110, limitation on an environment where the AV 110 performs at least part of the operation, limitation on a time when the AV 110 performs at least part of the operation, other types of limitations, or some combination thereof. The AV 110 can plan and control its behaviors during the operation based on the limitations.

In some embodiments, the operational plan is pre-defined, and the fleet management system 120 may generate the operational plan before the AV 110 operates to perform the service task. The fleet management system 120 may generate the operational plan based on information that is obtained by the fleet management system 120 before the operation of the AV 110. The information may be data received by the fleet management system 120 from the AV 110 or one or more other AVs 110, such as sensor data collected by the sensor suite 140 of each AV 110 during a historical operation. The historical operation may be in the same environment (e.g., same city, region, block, etc.) as the operation to be performed by the AV 110. Additionally or alternatively, the historical operation may be performed to provide the same type of service or to provide service to the same user (or the same group of users). The information may also include data received from third-party systems, such as systems that provide maps, weather predictions, road information, traffic information, and so on. The information may also include traffic rules, such as speed limit, requirement of yielding to pedestrians, restriction on an AV maneuver (e.g., U-turn, unprotected left turn, backing up, etc.), and so on.

The fleet management system 120 may send the same operational plan to multiple AVs 110. In some embodiments, the fleet management system 120 may send the same operational plan to AVs 110 operating in the same area, operating at the same time of period, operating for providing the same type of service, and so on. The AVs 110, after receiving the operational plan, may be able to dynamically modify the operational plan based on information the AVs 110 obtain during their operations to maximize utilization and efficiency and minimize safety risks.

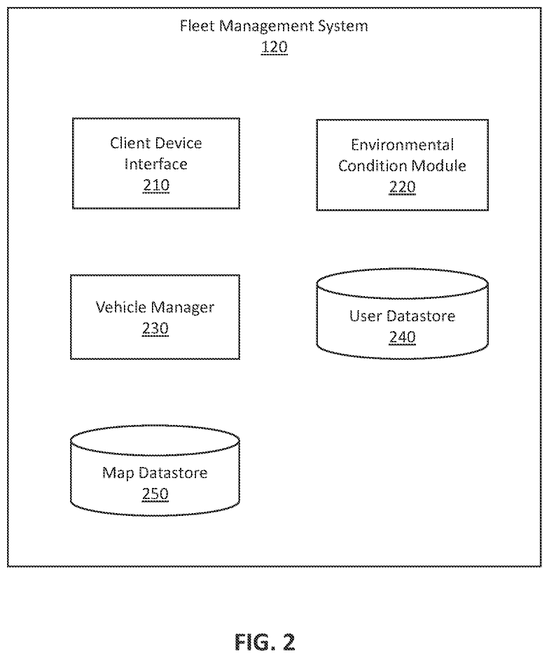

The fleet management system 120 may also provide software (“AV software”) to the fleet of AVs 110. The software, when executed by processors, may control operations of the AVs 110, e.g., based on the operational plan. The fleet management system 120 may provide different software to different AVs 110. The fleet management system 120 may also update software, e.g., by changing one or more components in a version of the AV software and releasing a new software version. The fleet management system 120 may also provide information to AVs 110 for the AVs 110 to operate based on the information. Certain aspects of the fleet management system 120 are described below in conjunction with FIG. 2.

A client device 130 may be a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, speakers, headphones, projectors, and so on. The client device 130 may be a desktop or a laptop computer, a smartphone, a mobile telephone, a personal digital assistant (PDA), or another suitable device.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may submit one or more service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to deliver one or more items from a location to another location), and so on. The UI may allow users 135 to provide locations (e.g., pickup location, destination location, etc.) or other information that would be needed by AVs 110 to provide services requested by the users 135. The client device 130 may also provide the user 135 an UI through which the user 135 may specify preference for AV motions during an AV service that has been requested or to be requested by the user 135. For example, the user 135 may specify, through the UI, how fast the user 135 prefers the AV 110 to move, turn, stop, accelerate, or decelerate.

The AV 110 is preferably a fully autonomous automobile, but may additionally or alternatively be any semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The sensor suite 140 may detect conditions inside and outside the AV 110. For instance, the sensor suite 140 may detect conditions in an environment surrounding the AV 110. The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 2.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. The onboard computer 150 may be preferably a general-purpose computer adapted for I/O communication with vehicle control systems and sensor suite 140 but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction.

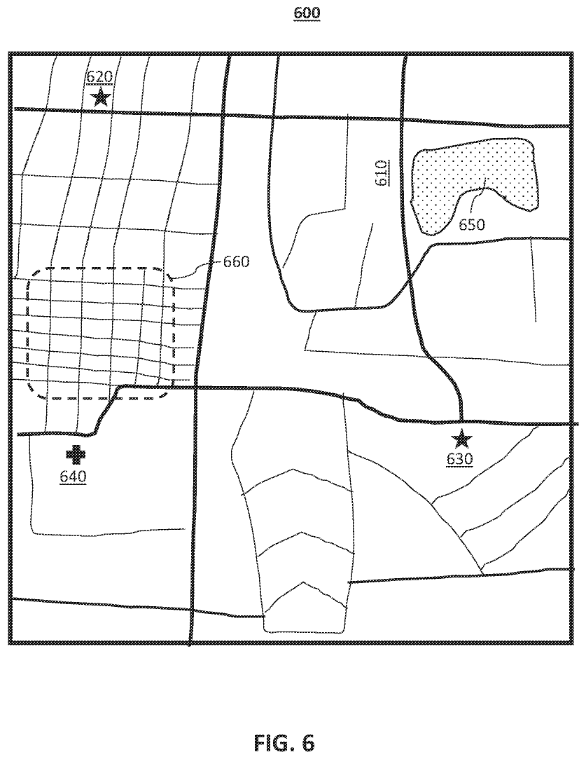

As another example, the onboard computer 150 may receive from the fleet management system 120 a request for sensor data to be used for determining environmental conditions. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on. Certain aspects of the onboard computer 150 are described further in relation to FIG. 6.

### Example Fleet Management System

FIG. 2 is a block diagram showing the fleet management system 120, according to some embodiments of the present disclosure. The fleet management system 120 may manage and monitor AVs, e.g., AVs 110 in FIG. 1. In FIG. 2, the fleet management system 120 includes a client device interface 210, an environmental condition module 220, a vehicle manager 230, a user datastore 240, and a map datastore 250. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The client device interface 210 may provide interfaces to client devices, such as headsets, smartphones, tablets, computers, and so on. The client device interface 210 may provide one or more apps or browser-based interfaces that can be accessed by users, such as the users 135, using client devices, such as the client devices 130. The client device interface 210 enables the users to submit requests to a ride service provided or enabled by the fleet management system 120. In an example, the client device interface 210 enables a user to submit a ride request that includes an origin (or pickup) location and a destination (or drop-off) location. The ride request may include additional information, such as a number of passengers traveling with the user, and whether or not the user is interested in a shared ride with one or more other passengers not known to the user. The client device interface 210 may enable the users to express their preferences for certain motions of the AV. The client device interface 210 may allow a user to indicate the user's preference for the AV's speed, acceleration rate, deceleration rate, jerk, snap, curvature, and so on. For instance, the client device interface 210 may allow a user to select whether the user prefers slow braking, normal braking, or harsh braking.

The environmental condition module 220 obtains information of environmental conditions in association with operations of AVs. An environmental condition is a condition in an environment surrounding the AV. The condition may be a condition of an object (e.g., building, structure, tree, vehicle, traffic sign, person, etc.) in the environment, a weather condition (e.g., rain, snow, ice, etc.), a road condition (e.g., road curvature, road slope angle, road closure, number of lanes, lane width, presence of turn-only lane, etc.), a traffic condition (e.g., traffic jam, accident, etc.), or other types of environmental conditions. The environmental condition module 220 may detect an environmental condition based on data (e.g., sensor data, perceptions, etc.) from one or more AVs, such as the AV operating in the environment, the same AV operating in the environment at a different time, or another AV operating in the environment. The environmental condition module 220 may request such data from AVs.

In some embodiment, the environmental condition module 220 may search for one or more AVs that operate in the environment at or near a time of interest (e.g., the time of an AV behavior) and after finding these AVs, the environmental condition module 220 can request data from these AVs. In some embodiments (e.g., embodiments where the environmental condition module 220 cannot find any AV operating in the environment but for the AV providing the service), the environmental condition module 220 may request the vehicle manager 260 to send an AV to the environment and capture data needed by the environmental condition module 220. The environmental condition module 220 may provide an instruction to the AV. The instruction may include information of the environment (e.g., location), information of objects that need to be detected, specification of sensors to be used, setting of sensors, and so on.

The environmental condition module 220 may also use other data to detect environmental conditions. For instance, the environmental condition module 220 may retrieve data from a third-party system that publishes information related to environmental conditions. The third-party system may be a third-party reporting traffic conditions, a third-party predicting weather conditions, a social-media system, and so on.

The vehicle manager 230 manages and communicates with the fleet of AVs. The vehicle manager 230 assigns the AVs to various tasks, such as service tasks. The vehicle manager 230 can also direct the operations of the AVs in the fleet by providing operational plans to the AVs. The vehicle manager 230 may generate operational plans based on data from other components of the fleet management system 120, such as the client device interface 210, the environmental condition module 220, the user datastore 240, or the map datastore 250, or some combination thereof. The data may be obtained by these components of the fleet management system 120 before the operations of the AVs are performed based on the operational plans. The vehicle manager 230 may request or extract data, which is relevant to the operations of the AVs, from one or more of these components of the fleet management system 120.

In the process of generating an operational plan, the vehicle manager 230 may define one or more operational limitations based on the data. An example limitation may be a limitation on a movement of the AV 110 during the operation, such as a speed limit, acceleration limit, deceleration limit, jerk limit (e.g., a limit on acceleration rate or deceleration rate), curvature limit, snap limit, and so on. Another example limitation may be a limitation on the environment where the AV 110 will operate. For instance, the operational plan may specify one or more geofenced areas, one or more weather conditions, one or more road conditions, and so on. Yet another example limitation may be a limitation on the time when the AV will operate. For instance, the operational plan may specify a start time, an end time, or a duration of time of the operation of the AV 110. Yet another example limitation may be a limitation on an attribute of the AV during the operation, such as the AV's location, orientation, battery charge level, and so on. Yet another example limitation may be a limitation on AV maneuvers (e.g., U-turn, unprotected left turn, backing up, etc.). For instance, an AV maneuver may be allowed in certain circumstances but not others. In some embodiments, the operational plan may include a limitation that is a combination of multiple limitations. For instance, the operational plan may specify a geofenced area where the AV 110 can drive for a particular time of period, a speed limit below which the AV 110 can drive under a particular weather condition, and so on.

The vehicle manager 230 may transmit an operational plan to an AV that receives a service task. For instance, the vehicle manager 230 can send the operational plan to the onboard computer (e.g., the onboard computer 150) of the AV. The vehicle manager 230 may generate different operational plans for different geographical regions where the AVs 110 will operate or for different types of service tasks to be performed by the AVs 110. In some embodiments, the vehicle manager 230 may periodically update operational plans as the data relevant to the operations of the AVs may change over time. Additionally or alternatively, the vehicle manager 230 may update an operational plan upon a request from an AV. For instance, an AV may determine that one or more limitations in the operational plan are not applicable any more and request the vehicle manager 230 to update the limitations. The AV may provide information that the vehicle manager 230 can use to update the operational plan.

In some embodiments, the vehicle manager 230 selects AVs from the fleet to perform various tasks and instructs the AVs to perform the tasks. For example, the vehicle manager 230 receives a ride request from the client device interface 210. The vehicle manager 230 selects an AV to service the ride request based on the information provided in the ride request, e.g., the origin and destination locations. If multiple AVs in the AV fleet are suitable for servicing the ride request, the vehicle manager 230 may match users for shared rides based on an expected compatibility. For example, the vehicle manager 230 may match users with similar user interests, e.g., as indicated by the user datastore 240. In some embodiments, the vehicle manager 230 may match users for shared rides based on previously-observed compatibility or incompatibility when the users had previously shared a ride.

The vehicle manager 230 or another system may maintain or access data describing each of the AVs in the fleet of AVs, including current location, service status (e.g., whether the AV is available or performing a service; when the AV is expected to become available; whether the AV is schedule for future service), fuel or battery level, etc. The vehicle manager 230 may select AVs for service in a manner that optimizes one or more additional factors, including fleet distribution, fleet utilization, and energy consumption. The vehicle manager 230 may interface with one or more predictive algorithms that project future service requests and/or vehicle use and select vehicles for services based on the projections.

The vehicle manager 230 transmits instructions dispatching the selected AVs. In particular, the vehicle manager 230 instructs a selected AV to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 230 may dispatch the same AV to pick up additional users at their pickup locations, e.g., the AV may simultaneously provide rides to three, four, or more users. The vehicle manager 230 further instructs the AV to drive autonomously to the respective destination locations of the users.

In some embodiments, the vehicle manager 230 may instruct AVs to drive to other locations while not servicing a user, e.g., to improve geographic distribution of the fleet, to anticipate demand at particular locations, etc. The vehicle manager 230 may also instruct AVs to return to an AV facility for fueling, inspection, maintenance, or storage.

The user datastore 240 stores information associated with users 135. The user datastore 240 stores information associated with rides requested or taken by the user 135. For instance, the user datastore 240 may store information of a ride currently being taken by a user 135, such as an origin location and a destination location for the user's current ride. The user datastore 240 may also store historical ride data for a user 135, including origin and destination locations, dates, and times of previous rides taken by a user. The user datastore 240 may also store expressions of the user 135 that are associated with a current ride or historical ride. In some cases, the user datastore 240 may further store future ride data, e.g., origin and destination locations, dates, and times of planned rides that a user has scheduled with the ride service provided by the AVs and fleet management system 120. Some or all of the information of a user 135 in the user datastore 240 may be received through the client device interface 210, an onboard computer (e.g., the onboard computer 150), a sensor suite of AVs (e.g., the sensor suite 140), a third-party system associated with the user and the fleet management system 120, or other systems or devices.

In some embodiments, the user datastore 240 stores data indicating user sentiments towards AV behaviors associated with ride services, such as information indicating whether a user feels comfortable or secured with an AV behavior. The fleet management system 120 may include one or more learning modules (not shown in FIG. 2) to learn user sentiments based on user data associated with AV rides, such as user expressions related to AV rides. The user datastore 240 may also store data indicating user interests associated with rides provided by AVs. The fleet management system 120 may include one or more learning modules (not shown in FIG. 2) to learn user interests based on user data. For example, a learning module may compare locations in the user datastore 240 with map datastore 250 to identify places the user has visited or plans to visit. For example, the learning module may compare an origin or destination address for a user in the user datastore 240 to an entry in the map datastore 250 that describes a building at that address. The map datastore 250 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 240.

In some embodiments, a user 135 is associated with a user profile stored in the user datastore 240. A user profile may include declarative information about the user 135 that was explicitly shared by the user 135 and may also include profile information inferred by the fleet management system 120. In one embodiment, the user profile includes multiple data fields, each describing one or more attributes of the user 135. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, an image of a user 135 may be tagged with information identifying the user 135 displayed in the image.

The map datastore 250 stores a detailed map of environments through which the AVs may travel. The map datastore 250 includes data describing roadways, such as e.g., locations of roadways, connections between roadways, roadway names, speed limits, traffic flow regulations, toll information, etc. The map datastore 250 may further include data describing buildings (e.g., locations of buildings, building geometry, building types), and data describing other objects (e.g., location, geometry, object type) that may be in the environments of AV. The map datastore 250 may also include data describing other features, such as bike lanes, sidewalks, crosswalks, traffic lights, parking lots, signs, billboards, etc.

Some of the map datastore 250 may be gathered by the fleet of AVs. For example, images obtained by the exterior sensors 310 of the AVs may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs may have one or more image processing modules to identify features in the captured images or other sensor data. This feature data may be stored in the map datastore 250. In some embodiments, certain feature data (e.g., seasonal data, such as Christmas decorations, or other features that are expected to be temporary) may expire after a certain period of time. In some embodiments, data captured by a second AV may indicate that a previously-observed feature is no longer present (e.g., a blow-up Santa has been removed) and in response, the fleet management system 120 may remove this feature from the map datastore 250.

### Example Sensor Suite

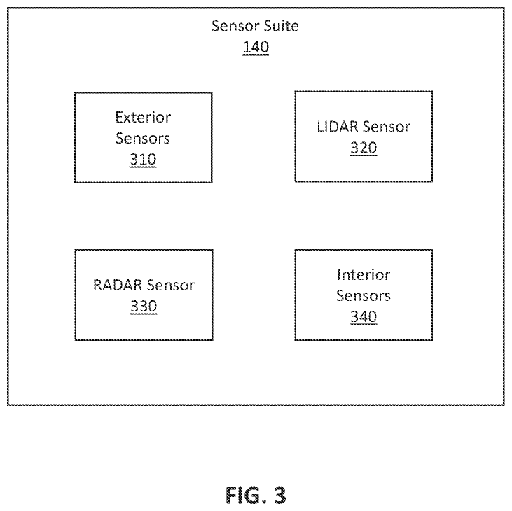

FIG. 3 is a block diagram showing the sensor suite 140, according to some embodiments of the present disclosure. The sensor suite 140 may be an onboard sensor suite of an AV, e.g., AV 110 in FIG. 1. The sensor suite 140 includes exterior sensors 310, a LIDAR sensor 320, a RADAR sensor 330, and interior sensors 340. The sensor suite 140 may include any number of the types of sensors shown in FIG. 3, e.g., one or more LIDAR sensors 320, one or more RADAR sensors 330, etc. The sensor suite 140 may have more types of sensors than those shown in FIG. 3, such as the sensors described with respect to FIG. 1. In other embodiments, the sensor suite 140 may not include one or more of the sensors shown in FIG. 3.

The exterior sensors 310 may detect objects in an environment around the AV. The environment may include a scene in which the AV operates. Example objects include objects related to weather (e.g., fog, rain, snow, haze, etc.), persons, buildings, traffic lights, traffic signs, vehicles, street signs, trees, plants, animals, or other types of objects that may be present in the environment around the AV. In some embodiments, the exterior sensors 310 include exterior cameras having different views, e.g., a front-facing camera, a back-facing camera, and side-facing cameras. One or more exterior sensors 310 may be implemented using a high-resolution imager with a fixed mounting and field of view. One or more exterior sensors 310 may have adjustable field of views and/or adjustable zooms. In some embodiments, the exterior sensors 310 may operate continually during operation of the AV. In an example embodiment, the exterior sensors 310 capture sensor data (e.g., images, etc.) of a scene in which the AV drives. In other embodiment, the exterior sensors 310 may operate in accordance with an instruction from the onboard computer 150 or an external system, such as the vehicle manager 230 of the fleet management system 120. Some of all of the exterior sensors 310 may capture sensor data of one or more objects in an environment surrounding the AV based on the instruction.

The LIDAR sensor 320 may measure distances to objects in the vicinity of the AV using reflected laser light. The LIDAR sensor 320 may be a scanning LIDAR that provides a point cloud of the region scanned. The LIDAR sensor 320 may have a fixed field of view or a dynamically configurable field of view. The LIDAR sensor 320 may produce a point cloud that describes, among other things, distances to various objects in the environment of the AV.

The RADAR sensor 330 may measure ranges and speeds of objects in the vicinity of the AV using reflected radio waves. The RADAR sensor 330 may be implemented using a scanning RADAR with a fixed field of view or a dynamically configurable field of view. The RADAR sensor 330 may include one or more articulating RADAR sensors, long-range RADAR sensors, short-range RADAR sensors, or some combination thereof.

The interior sensors 340 may detect the interior of the AV, such as objects inside the AV. Example objects inside the AV include users (e.g., passengers), client devices of users, components of the AV, items delivered by the AV, items facilitating services provided by the AV, and so on. The interior sensors 340 may include multiple interior cameras to capture different views, e.g., to capture views of an interior feature, or portions of an interior feature. The interior sensors 340 may be implemented with a fixed mounting and fixed field of view, or the interior sensors 340 may have adjustable field of views and/or adjustable zooms, e.g., to focus on one or more interior features of the AV. The interior sensors 340 may transmit sensor data to a perception module (such as the perception module 430 described below in conjunction with FIG. 3), which can use the sensor data to classify a feature and/or to determine a status of a feature.

In some embodiments, the interior sensors 340 include one or more input sensors that allow users 135 to provide input. For instance, a user 135 may use an input sensor to provide information indicating his/her preference for one or more motions of the AV during the ride. The input sensors may include touch screen, microphone, keyboard, mouse, or other types of input devices. In an example, the interior sensors 340 include a touch screen that is controlled by the onboard computer 150. The onboard computer 150 may present questionnaires on the touch screen and receive user answers to the questionnaires through the touch screen. A questionnaire may include one or more questions about AV motions. The onboard computer 150 may receive the questions from the fleet management system 120. In some embodiments, some or all of the interior sensors 340 may operate continually during operation of the AV. In other embodiment, some or all of the interior sensors 340 may operate in accordance with an instruction from the onboard computer 150 or an external system, such as the fleet management system 120.

### Example Onboard Computer

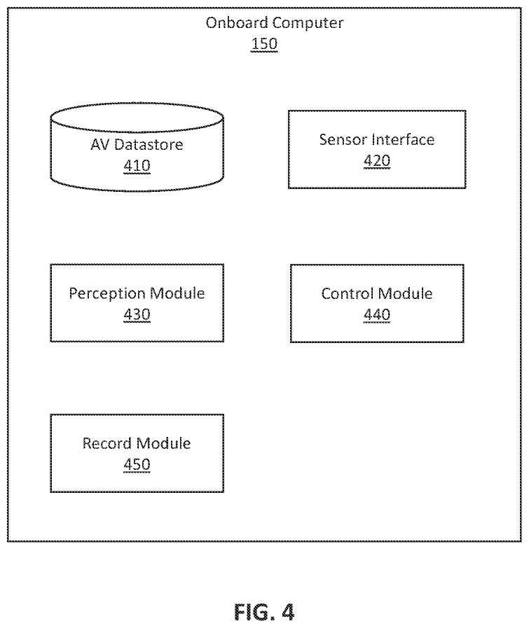

FIG. 4 is a block diagram showing the onboard computer 150 according to some embodiments of the present disclosure. The onboard computer 150 may control an AV, e.g., AV 110 in FIG. 1. As shown in FIG. 4, the onboard computer 150 includes an AV datastore 410, a sensor interface 420, a perception module 430, a control module 440, and a record module 450. In alternative configurations, fewer, different and/or additional components may be included in the onboard computer 150. For example, components and modules for conducting route planning, controlling movements of the AV, and other vehicle functions are not shown in FIG. 4. Further, functionality attributed to one component of the onboard computer 150 may be accomplished by a different component included in the onboard computer 150 or a different system, such as the fleet management system 120.

The AV datastore 410 stores data associated with operations of the AV. The AV datastore 410 may store one or more operation records of the AV. An operation record is a record of an operation of the AV, e.g., an operation for providing a ride service. The operation may be a currently performed operation or a previously performed operation (“previous operation” or “historical operation”). The operation record may include information indicating operational behaviors of the AV during the operation. The operational behaviors may include sensor detection, movement, stop, battery charging, calibration, maintenance, communication with the fleet management system 120, communication with assistance agent, communication with user, communication with another AV, and so on. The operations record may also include data used, received, or captured by the AV during the operation, such as map data, instructions from the fleet management system 120, sensor data captured by the AV's sensor suite, and so on. In some embodiments, the AV datastore 410 stores a detailed map that includes a current environment of the AV. The AV datastore 410 may store data in the map datastore 250. In some embodiments, the AV datastore 410 stores a subset of the map datastore 250, e.g., map data for a city or region in which the AV is located.

The data in the AV datastore 410 may include data generated by the AV itself. The data may include sensor data capturing one or more environments where the AV operates, e.g., operates to provide services. The sensor data may be from the sensor suite 140 of the AV. The data in the AV datastore 410 may also include perception data that identifies one or more environmental conditions. The perfection data may be from the perception module 430 of the onboard computer 150 of the AV. The data may also include external data, e.g., data from other AVs or systems. For example, the data in the AV datastore 410 may include data (e.g., sensor data, perception, etc.) from one or more other AVs that capture one or more environments where the other AVs operate. As another example, the data in the AV datastore 410 may include data from the fleet management system 120, e.g., data about environmental conditions from the environmental condition module 220 or instructions (e.g., operational plans) from the vehicle manager 230. In yet another example, the data in the AV datastore 410 may include data from one or more third-party systems that provide information of environments where the AV operates. The AV may be in communication with the one or more third-party systems, e.g., through a network.

The sensor interface 420 interfaces with the sensors in the sensor suite 140. The sensor interface 420 may request data from the sensor suite 140, e.g., by requesting that a sensor capture data in a particular direction or at a particular time. For example, the sensor interface 420 instructs the sensor suite 140 to capture sensor data of an environment surrounding the AV, e.g., by sending a request for sensor data to the sensor suite 140. In some embodiments, the request for sensor data may specify which sensor(s) in the sensor suite 140 to provide the sensor data, and the sensor interface 420 may request the sensor(s) to capture data. The request may further provide one or more settings of a sensor, such as orientation, resolution, accuracy, focal length, and so on. The sensor interface 420 can request the sensor to capture data in accordance with the one or more settings.

A request for sensor data may be a request for real-time sensor data, and the sensor interface 420 can instruct the sensor suite 140 to immediately capture the sensor data and to immediately send the sensor data to the sensor interface 420. The sensor interface 420 is configured to receive data captured by sensors of the sensor suite 140, including data from exterior sensors mounted to the outside of the AV, and data from interior sensors mounted in the passenger compartment of the AV. The sensor interface 420 may have subcomponents for interfacing with individual sensors or groups of sensors of the sensor suite 140, such as a camera interface, a LIDAR interface, a RADAR interface, a microphone interface, etc.

The perception module 430 identifies objects and/or other features captured by the sensors of the AV. For example, the perception module 430 identifies objects in the environment of the AV and captured by one or more sensors (e.g., the sensors 210-230). As another example, the perception module 430 determines one or more environmental conditions based on sensor data from one or more sensors (e.g., the sensors 210-230). The perception module 430 may include one or more classifiers trained using machine learning to identify particular objects. For example, a multi-class classifier may be used to classify each object in the environment of the AV as one of a set of potential objects, e.g., a vehicle, a pedestrian, or a cyclist. As another example, a pedestrian classifier recognizes pedestrians in the environment of the AV, a vehicle classifier recognizes vehicles in the environment of the AV, etc. The perception module 430 may identify travel speeds of identified objects based on data from the RADAR sensor 330, e.g., speeds at which other vehicles, pedestrians, or birds are traveling. As another example, the perception module 43—may identify distances to identified objects based on data (e.g., a captured point cloud) from the LIDAR sensor 320, e.g., a distance to a particular vehicle, building, or other feature identified by the perception module 430. The perception module 430 may also identify other features or characteristics of objects in the environment of the AV based on image data or other sensor data, e.g., colors (e.g., the colors of Christmas lights), sizes (e.g., heights of people or buildings in the environment), makes and models of vehicles, pictures and/or words on billboards, etc.

In some embodiments, the perception module 430 fuses data from one or more interior sensors 340 with data from exterior sensors (e.g., exterior sensors 310) and/or AV datastore 410 to identify environmental objects that one or more users are looking at. The perception module 430 determines, based on an image of a user, a direction in which the user is looking, e.g., a vector extending from the user and out of the AV in a particular direction. The perception module 430 compares this vector to data describing features in the environment of the AV, including the features' relative location to the AV (e.g., based on real-time data from exterior sensors and/or the AV's real-time location) to identify a feature in the environment that the user is looking at.

While a single perception module 430 is shown in FIG. 4, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 440 controls behaviors of the AV based on an operational plan. The control module 440 can dynamically update the operational plan based on information obtained during the operation of the AV and control one or more behaviors of the AV based on the updated operational plan. The information may be received by the control module from another component of the onboard computer 150 (e.g., the sensor interface 420 or the perception module 430), from another AV, or from the fleet management system 120 or a different system. The information may indicate one or more environmental conditions, one or more user preferences, operational capability of one or more AV components (e.g., motor, brake, etc.), and so on.

The control module 440 may use the information to modify one or more limitations in the operational plan. The control module 440 may predict a performance of the AV operation within or beyond a limitation based on the information. The performance may be a safety risk, passenger comfort, or a combination of both. The control module 440 may determine a performance score that measures the predicted performance of the AV within or beyond the limitation. In embodiments where the control module 440 determines that the predicted performance is below a threshold performance (e.g., the safety risk is beyond a threshold risk level) if the AV operates within the limitation, the control module 440 may modify the limitation to improve the predicted performance. The modified limitation is more restrictive than the original limitation. In embodiments where the control module 440 determines that the predicted performance is above a threshold performance (e.g., the safety risk is above a threshold risk level) if the AV operates beyond the limitation, the control module 440 may modify the limitation to improve utilization or efficiency of the AV's operation. The modified limitation is less restrictive than the original limitation.

The control module 440 may update the operational plan multiple times during the AV's operation, e.g., based on changes in environmental conditions, user preferences, etc. The modification of the operational plan can therefore be dynamic. The modification of the operational plan can also be real-time. For instance, in response to receiving sensor data capturing a change in an environmental condition or user preference, the control module 440 determines whether to modify the operational plan. In some embodiments, the control module 440 may use a trained model to predict the performance of the AV. Additionally or alternatively, the control module 440 may use the performance of the AV in one or more historical operations to predict the performance of the AV. The historical operations may be performed by the AV in the same environment, under the same or similar environmental conditions, or upon service request from the same user or similar users.

In some embodiments, the operational plan may include one or more limitations that cannot be modified by the control module 440, such as limitations that were defined to meet a legal requirement. In some embodiments, the control module 440 may need to request for authorization before a limitation can be modified. For instance, the control module 440 may send a request for authorization of changing a limitation to the vehicle manager 230 or an agent of the fleet management system 120. The control module 440 may make the change after it receives the authorization. Alternatively, the vehicle manager 230 or an agent of the fleet management system 120 may change the limitation remotely.

In some embodiments, the control module 440 may include one or more planning modules (also referred to as “planners”) that can plan motions of the AV during the AV's operations based on the dynamically updated operational plan. The planning module(s) may determine a motion parameter that specifies a motion to be performed by the AV in the operation. The motion parameter may be a speed, acceleration rate, deceleration rate, jerk, snap, curvature, orientation, etc. The motion parameter may have a value within a limitation specified in the operational plan. Different planning modules may make different plans for the AV. The planning modules may use different models to make the different plans. In some embodiments, the planning modules may produce a single plan for the operation of the AV. In an example, the planning modules may run in a sequence. For instance, a planning module may generate a plan, and another planning module may generate another plan based on the plan. The output from the last planning module in the sequence may be the final plan for the AV's operation. The output may include commands, e.g., commands to one or more actuators in the AV.

In some embodiments, the control module 440 controls operation of the AV by using a trained control model, such as a trained neural network. The control module 440 may provide input data to the control model, and the control model outputs operation parameters for the AV. The input data may include sensor data from the sensor interface 420 (which may indicate a current state of the AV), objects identified by the perception module 430, or both. The operation parameters are parameters indicating operation to be performed by the AV. The operation of the AV may include perception, prediction, planning, localization, motion, navigation, other types of operation, or some combination thereof.

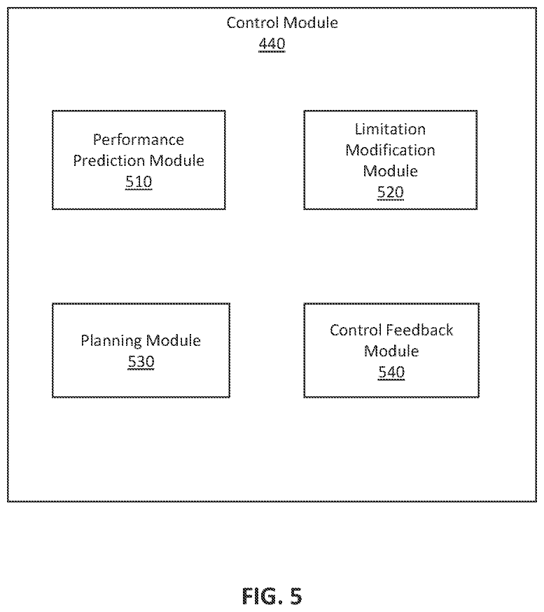

The control module 440 may provide instructions to various components of the AV based on the output of the control model, and these components of the AV will operate in accordance with the instructions. In an example where the output of the control model indicates that a change of traveling speed of the AV is required given a prediction of traffic condition, the control module 440 may instruct the motor of the AV to change the traveling speed of the AV. In another example where the output of the control model indicates a need to detect characteristics of an object in the environment around the AV (e.g., detect a speed limit), the control module 440 may instruct the sensor suite 140 to capture an image of the speed limit sign with sufficient resolution to read the speed limit and instruct the perception module 430 to identify the speed limit in the image. In some embodiments, the control module 440 may control one or more actuators in the AV based on an output of one or more planners. In some embodiments, the control module 440 may execute commands in the output of a planner to drive operations of the one or more actuators. The operations of the actuators can cause the AV motions planned by the planner. Certain aspects of the control module 440 are provided below in conjunction with FIG. 5.

The record module 450 generates operation records of the AV and stores the operations records in the AV datastore 410. The record module 450 may generate an operation record in accordance with an instruction from the fleet management system 120, e.g., the vehicle manager 230. The instruction may specify data to be included in the operation record. The record module 450 may determine one or more timestamps for an operation record. In an example of an operation record for a ride service, the record module 450 may generate timestamps indicating the time when the ride service starts, the time when the ride service ends, times of specific AV behaviors associated with the ride service, and so on. The record module 450 can transmit the operation record to the fleet management system 120.

### Example Control Module

FIG. 5 is a block diagram showing the control module 440, according to some embodiments of the present disclosure. The control module 440 includes a performance prediction module 510, a limitation modification module 520, a planning module 530, and a control feedback module 540. In alternative configurations, different and/or additional components may be included in the control module 440. For instance, the control module 440 may include more than one planning module 530. Further, functionality attributed to one component of the control module 440 may be accomplished by a different component included in the control module 440, a different component included in the onboard computer 150, or a different system (such as the fleet management system 120).

The performance prediction module 510 predicts performances of the AV operating within or beyond limitations in operational plans. The performance prediction module 510 may evaluate a performance of the AV if the AV operates within or beyond an operational limitation in an operational plan. The performance of the AV may indicate a predicted safety or passenger comfort (or both) when the AV operates within or beyond the limitation. In some embodiments, the performance prediction module 510 may determine a performance score that indicates how safe it will be when the AV operates following the limitation. For instance, the performance score can indicate the safety risk of the AV operating within the limitation. The performance prediction module 510 may determine the performance score based on the limitation and one or more environmental conditions under which the AV will perform within the limitation. In some embodiments, the performance score may indicate a combination of safety risk and passenger comfort. For instance, the performance score may be an aggregation of a safety score, which measures the safety risk, and a comfort score, which measures the passenger comfort. In an embodiment, the performance score may be a weighted sum of the safety score and the comfort score. The performance prediction module 510 may determine the weights of the safety score and the comfort score. Additionally or alternatively, the performance prediction module 510 may determine a performance score for an operation of the AV beyond the limitation.

In some embodiments, the performance prediction module 510 may use a model trained with machine learning techniques to predict the AV's performance. The performance prediction module 510 may input the limitation and one or more environmental conditions into the model. The performance prediction module 510 may also input information of one or more components of the AV into the model. The information may indicate capability or specifications of the components. The model outputs a prediction of the AV performance. In some embodiments, the model can output the performance score.

The performance prediction module 510 may include or be associated with a training module that trains the model with machine learning techniques. As part of the generation of the model, the training module may form a training set. The training set may include training samples and ground-truth labels of the training samples. A training sample may include a set of data associated with an operational limitation and one or more environmental conditions under which an AV operates within the operational limitation. The training sample may have one or more ground-truth labels, e.g., one or more verified or known performances of the AV. The training module extracts feature values from the training set, the features being variables deemed potentially relevant to AV performance. An ordered list of the features for a ride service may be a feature vector for the ride service. In some embodiments, the training module may apply dimensionality reduction (e.g., via linear discriminant analysis (LDA), principal component analysis (PCA), or the like) to reduce the amount of data in the feature vectors for ride services to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, the performance prediction module 510 may use historical AV operations to predict the AV performance of operating within the operational limitation. The performance prediction module 510 may compare the to-be-performed operation of the AV within the operational limitation with one or more historical operations and identify one or more historical operations that are the same or similar as the to-be-performed operation of the AV. A same or similar historical operation may have been performed within the same or similar operational limitation, under the same or similar environmental condition(s), for the same or similar type of service, by the same or similar AV (e.g., AV including components with the same capability or specifications), or some combination thereof. The performance prediction module 510 can use the AV performance in the same or similar historical operation(s) to predict the performance of the AV in the to-be-performed operation. In an example, the AV has not operated in a driverless mode (e.g., a mode where no driver is present in the AV) in a local area but has operated in a supervised mode (e.g., a mode where one or more safety operators are present in the AV and may intervene in the operation of the AV when needed) one or more times without the need for safety operator intervention. The performance prediction module 510 can that predict it would be safe for the AV to operate in the local area in the driverless mode.

In some embodiments, the performance prediction module 510 may predict the AV performance of operating within the operational limitation based on an estimated capability of the AV under the current environmental conditions. For instance, the performance prediction module 510 may determine one or more vehicle capability parameters based on the one or more environmental conditions. The vehicle capability parameters may indicate capabilities of the AV for making different types of motions, e.g., limits of the AV making different motions. Examples of vehicle capability parameters may include speed limit, acceleration limit, deceleration limit, jerk limit (e.g., a limit on acceleration rate or deceleration rate), curvature limit, snap limit, and so on. The performance prediction module 510 may compare the vehicle capability with the operational limitation. In response to determine that the operational limitation is beyond the vehicle capability, the performance prediction module 510 may determine that there will be a safety risk when the AV operates following the operational limitation. In response to determine that the operational limitation is below the vehicle capability, the performance prediction module 510 may determine that there will be no safety risk when the AV operates beyond the operational limitation.

The limitation modification module 520 dynamically modifies operational plans based on AV performance predicted by the performance prediction module 510. In embodiments where the performance prediction module 510 determines a performance score, the limitation modification module 520 may compare the performance score with a threshold score, which may indicate a threshold performance (such as a required performance), to determine whether and how to modify a limitation in an operational plan.

The limitation modification module 520 may make a limitation more restrictive in response to a determination that the predicted performance of the AV operating within the limitation is below a threshold performance, e.g., below a threshold safety requirement. In embodiments where the limitation specifies a range (e.g., a range for a motion limit), the limitation modification module 520 may use a subset of the range as a new limitation to replace the original limitation. In an example, the limitation specifies a speed limit of 50-70 mph (miles per hour), the limitation modification module 520 may change the speed limit to 50-60 mph based on a determination that it would be unsafe if the AV drives at 60-70 mph, e.g., due to severe weather condition. In another example, the limitation specifies a road slope angle of no more than three degrees, the limitation modification module 520 may change the limitation to a road slope angle of no more than two degrees based on a detection of ice on the road.

The limitation modification module 520 may make a limitation less restrictive in response to a determination that the predicted performance of the AV operating beyond the limitation is above a threshold performance, e.g., above a threshold safety requirement. The limitation modification module 520 may also determine that the AV is capable of operating beyond the limitation before making the limitation less restrictive. In an example, the limitation may specify the AV takes no less than six seconds to accelerate from 0 mph to 60 mph. The limitation modification module 520 may extend the acceleration time limit to no less than four seconds based on a determination that it will be safe that the AV takes four seconds to accelerate from 0 mph to 60 mph and that the AV's motor is capable of such acceleration.

The limitation modification module 520 may consider other factors to determine whether and how to modify a limitation. In some embodiments, the limitation modification module 520 may consider the preference of a user that receives a service provided through the AV's operation. In an example, the limitation requires the AV to avoid a particular region during rush hours to avoid traffic. The limitation modification module 520 may remove the limitation from the operational plan based on a determination that it is safe for the AV to drive in the region during the rush hours and that the user prefers the AV to drive in the region. A user preference may be an explicit preference provided by the user or an implicit preference determined based on information of the user or information of similar users, e.g., information in the user datastore 240.

In some embodiments, the limitation modification module 520 may use a model trained with machine learning techniques to determine new limitations that can maximize utilization and efficiency of the AV and minimize safety risks. The limitation modification module 520 may input into the model data about environment condition, AV capability, AV historical performance data, user preference, or some combination thereof. The model outputs a new limitation that can maximize utilization and efficiency of the AV and minimize safety risks. The limitation modification module 520 can replace the original limitation with the new limitation and generates a new operational plan.

The limitation modification module 520 may include or be associated with a training module that trains the model with machine learning techniques, such as the machine learning techniques described above. As part of the generation of the model, the training module may form a training set. The training set may include training samples and ground-truth labels of the training samples. A training sample may include a set of data associated with an AV operation, such as data about environment condition, AV capability, AV historical performance data, user preference, or some combination thereof. The training sample may have one or more ground-truth labels, e.g., one or more operational limitations that have been verified or known to maximize utilization and efficiency of the AV and minimize safety risks. The training set may include one or more positive training samples and one or more negative training samples. A training sample may be an AV operation in which the AV performance is desired, e.g., the AV operation was safe, the passenger was comfortable, or both. A training sample may be an AV operation in which the AV performance is undesired, e.g., the AV operation was unsafe, the passenger was uncomfortable, or both. More details regarding dynamic modifications of operational plans are provided below in conjunction with FIG. 6.

The planning module 530 makes plans for AV behaviors based on operational plans provided by the limitation modification module 520. For instance, the planning module 530 may plan for motions of the AV in an operation based on motion limits specified in an operational plan. The planning module 530 may determine a motion parameter that specifies a motion to be performed by the AV in the operation. The motion parameter may be a speed, acceleration rate, deceleration rate, jerk, snap, curvature, orientation, etc. The motion parameter may be determined based on one or more vehicle capability parameters. In some embodiments, the value of the motion parameter may fall into a limit specified by a vehicle capability parameter.

In some embodiments, the control module may include multiple planning modules. Different planning modules may make different plans for the AV. The planning modules may use different models to make the different plans. The planning modules may run in a sequence. A planning module may generate a plan based on one or more vehicle capability parameters. Another planning module may generate another plan based on the plan and one or more vehicle capability parameters. The output from the last planning module in the sequence may be the final plan for the AV's operation. The output may include commands, e.g., commands to one or more actuators in the AV.

The control feedback module 540 obtains information indicating feedback of AV behaviors determined in accordance with operational plans provided by the limitation modification module 520. The feedback information may include information in the operation record of the AV that indicates how well the AV performed during the operation, such as sensor data indicating whether there is a near-miss, data indicating harsh braking, data indicating oversteering, and so on. The feedback information may also include user feedback, e.g., a communication from the user that indicates how much the user is satisfied with the service provided by the AV, a sentiment of the user during or after the service, and so on. The control feedback module 540 may provide the feedback information to the limitation modification module 520.

In some embodiments, the limitation modification module 520 may use the feedback information as feedback of the limitation modifications made by the limitation modification module 520 and can improve future limitation modifications based on the feedback information. For instance, the limitation modification module 520 may use the feedback information as new training samples to continuously train the machine learning model that determines new limitations. Positive feedback, which indicates that limitations determined by the limitation modification module 520 result in desired performances of the AV, may be used as a positive training sample. Negative feedback, which indicate that limitations determined by the limitation modification module 520 result in undesired performances of the AV, may be used as a negative training sample.

### Example Dynamic Modification of Operational Plans

FIG. 6 illustrates examples of dynamic modifications of operational plans, according to some embodiments of the present disclosure. For the purpose of illustration, FIG. 6 shows an environment 600, which is an area including a plurality of roads that are represented by lines in FIG. 6. The plurality of roads includes a road 610 that is located by a lake 650. For simplicity, the other roads are not called out with reference numbers, even though they are shown in FIG. 6. The environment 600 includes a downtown area 660 where typically has more traffic than other areas.

In the embodiments of FIG. 6, an AV (not shown in FIG. 6) receives a delivery service task to deliver an item from a location 620 in the environment 600 to another location 630 in the environment. Another AV (not shown in FIG. 6) receives a ride service task to give a person a ride from the location 620 to another location 640 in the environment. The location 640 is a location of a hospital. The two AVs may be AVs 110 that are in communication with the fleet management system 120. The fleet management system 120 (e.g., the vehicle manager of the fleet management system 120) may provide information of the service tasks to the AVs, such as the locations 620, 630, and 640, pickup time, drop-off time, information of the person, and so on. The fleet management system 120 may also provide an operational plan to each AV, which specifies one or more limitations on the operation of the AV for performing the service task. In some embodiments, the two AVs may receive the same operational plan.

For the AV providing the delivery service, the AV will drive on the road 610 to navigate from the location 620 to the location 630. The operational plan may include a speed limit for the road 610, which is lower than the legally required speed limit, based on a prediction of fog on the road 610 given the presence of a lake 650 by the road 610. The lower speed limit may be determined by the fleet management system 120 before the operation of the AV based on data collected by one or more AVs that have been operated on the road 610 or data received from a weather prediction system. As the AV operates to perform the delivery service, the AV's exterior sensor(s) can detect weather conditions in the environment 600.

The AV can detect the fog condition on the road 610 when it drives along the road 610. In some embodiments, the AV may determine that there is no fog or that the fog is so thin that it does not influence the normal operation of the AV. In response to such a determination, the AV may change the operational plan and increase the speed limit, e.g., to the legally required speed limit. With the higher speed limit, the utilization and efficiency of the AV can be improved without causing any safety risks. In other embodiments, the AV may determine that the fog is so dense that it is unsafe for the AV to drive with the speed limit specified in the operational plan. In response to such a determination, the AV may reduce the speed limit in the operational plan to a speed limit that is safe for the AV to drive in the dense fog. With the lower speed limit, the safety risk caused by the dense fog can be minimized.

For the AV providing the ride service, the operational plan may include a limitation that the AV does not enter the downtown area 660. As the downtown area 660 is in the downtown of the city and the time of the ride service is in rush hours, the fleet management system 120 predicts that the traffic will be very bad in the downtown area 660. The AV may make a navigation plan based on the limitation to avoid the downtown area 660 and present the navigation plan to the person riding the AV. The person may provide the AV a comment indicating that he or she prefers to enter the downtown area 660 as he or she is interested in the view in the downtown area 660. The AV, receiving the comment from the person, may determine that there is no safety risk to drive in the downtown area 660. And given the person's preference, the AV can remove the limitation from the operational plan and determine a navigation route through the downtown area 660. Thus, the AV's change of the operational plan can promote user satisfaction with the ride service without sacrificing the safety of the AV's operation.

### Example Method of Mitigating AV Service Outage

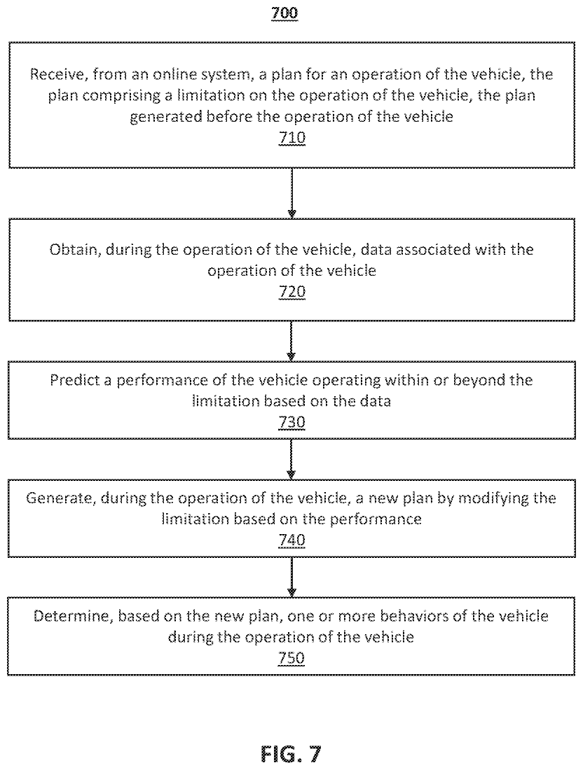

FIG. 7 is a flowchart showing a method 700 of dynamically modifying a pre-defined operational plan for an AV, according to some embodiments of the present disclosure. The method 700 may be performed by the control module 440. Although the method 700 is described with reference to the flowchart illustrated in FIG. 7, many other methods of broadcasting vehicle capabilities to planning modules may alternatively be used. For example, the order of execution of the steps in FIG. 7 may be changed. As another example, some of the steps may be changed, eliminated, or combined.

The control module 440 receives, in 710, from an online system, a plan for an operation of the vehicle. The online system may be the fleet management system 120. The plan includes a limitation on the operation of the vehicle. The plan is generated before the operation of the vehicle. In some embodiments, the limitation is a limitation on an attribute of the vehicle, a movement of the vehicle, an environment where the vehicle performs at least part of the operation, or a time when the vehicle performs at least part of the operation.

The control module 440 obtains, in 720, by the vehicle during the operation of the vehicle, data associated with the operation of the vehicle. The data may include sensor data captured by one or more sensors of the vehicle or another vehicle that operates in an environment where the vehicle performs the operation. In some embodiments, the operation of the vehicle is for providing a service to a user of the online system, and the data includes data indicating a preference of the user. In some embodiments, the data includes data indicating a capability of one or more components of the vehicle.

The control module 440 predicts, in 730, a performance of the vehicle operating within or beyond the limitation based on the data. The performance may be safety, passenger comfort, or a combination of both. In some embodiments, the control module 440 may input the data into a trained model. The trained model outputs a prediction of the performance of the vehicle. In other embodiments, the data includes data indicating a condition of an environment in which the vehicle performs the operation. The control module 440 may predict a safety risk of the vehicle operating within or beyond the limitation based on a performance of the vehicle in a previous operation under the condition.

The control module 440 generates, in 740, during the operation of the vehicle, a new plan by modifying the limitation based on the performance. In some embodiments, the control module 440 determines that there is a safety risk to operate within the limitation based on the data and modifies the limitation to reduce the safety risk. For instance, the data may include data indicating a condition of an environment in which the vehicle performs the operation. The control module 440 may determine that there is a safety risk to operate within the limitation under the condition. In other embodiments, the control module 440 determines that there is no safety risk to operate beyond the limitation and extends the limitation.

The control module 440 determines, in 750, based on the new plan, one or more behaviors of the vehicle during the operation of the vehicle. The one or more behaviors of the vehicle meet the modified limitation.

### Select Examples

Example 1 provides a method, including receiving, by a vehicle from an online system, a plan for an operation of the vehicle, the plan including a limitation on the operation of the vehicle, the plan generated before the operation of the vehicle; obtaining, by the vehicle during the operation of the vehicle, data associated with the operation of the vehicle; predicting a performance of the vehicle operating within or beyond the limitation based on the data; generating, by the vehicle during the operation of the vehicle, a new plan by modifying the limitation based on the performance; and determining, based on the new plan, one or more behaviors of the vehicle during the operation of the vehicle.

Example 2 provides the method of example 1, where the data includes sensor data captured by one or more sensors of the vehicle or another vehicle that operates in an environment where the vehicle performs the operation.

Example 3 provides the method of example 1, where the operation of the vehicle is for providing a service to a user of the online system, and the data includes data indicating a preference of the user.

Example 4 provides the method of example 1, where the data includes data indicating a capability of one or more components of the vehicle.

Example 5 provides the method of example 1, where modifying the limitation based on the performance includes determining that there is a safety risk to operate within the limitation; and modifying the limitation to reduce the safety risk.

Example 6 provides the method of example 5, where the data includes data indicating a condition of an environment in which the vehicle performs the operation, and determining that there is a safety risk to operate within the limitation includes determining that there is a safety risk to operate within the limitation under the condition.

Example 7 provides the method of example 1, where modifying the limitation based on the performance includes determining that there is no safety risk to operate beyond the limitation; and extending the limitation.

Example 8 provides the method of example 1, where predicting the performance of the vehicle operating within or beyond the limitation based on the data includes inputting the data into a trained model, the trained model outputting a prediction of the performance of the vehicle.

Example 9 provides the method of example 1, where the data includes data indicating a condition of an environment in which the vehicle performs the operation, and predicting the performance of the vehicle operating within or beyond the limitation based on the data includes predicting a safety risk of the vehicle operating within or beyond the limitation based on a performance of the vehicle in a previous operation under the condition.

Example 10 provides the method of example 1, where the limitation is a limitation on an attribute of the vehicle, a movement of the vehicle, an environment where the vehicle performs at least part of the operation, or a time when the vehicle performs at least part of the operation.

Example 11 provides one or more non-transitory computer-readable media storing instructions executable to perform operations, the operations including receiving, by a vehicle from an online system, a plan for an operation of the vehicle, the plan including a limitation on the operation of the vehicle, the plan generated before the operation of the vehicle; obtaining, by the vehicle during the operation of the vehicle, data associated with the operation of the vehicle; predicting a performance of the vehicle operating within or beyond the limitation based on the data; generating, by the vehicle during the operation of the vehicle, a new plan by modifying the limitation based on the performance; and determining, based on the new plan, one or more behaviors of the vehicle during the operation of the vehicle.

Example 12 provides the one or more non-transitory computer-readable media of example 11, where the data includes sensor data captured by one or more sensors of the vehicle or another vehicle that operates in an environment where the vehicle performs the operation.

Example 13 provides the one or more non-transitory computer-readable media of example 11, where the operation of the vehicle is for providing a service to a user of the online system, and the data includes data indicating a preference of the user.

Example 14 provides the one or more non-transitory computer-readable media of example 11, where the data includes data indicating a capability of one or more components of the vehicle.

Example 15 provides the one or more non-transitory computer-readable media of example 11, where modifying the limitation based on the performance includes determining that there is a safety risk to operate within the limitation; and modifying the limitation to reduce the safety risk.

Example 16 provides the one or more non-transitory computer-readable media of example 11, where modifying the limitation based on the performance includes determining that there is no safety risk to operate beyond the limitation; and extending the limitation.

Example 17 provides a computer system, including a computer processor for executing computer program instructions; and one or more non-transitory computer-readable media storing computer program instructions executable by the computer processor to perform operations including receiving, by a vehicle from an online system, a plan for an operation of the vehicle, the plan including a limitation on the operation of the vehicle, the plan generated before the operation of the vehicle, obtaining, by the vehicle during the operation of the vehicle, data associated with the operation of the vehicle, predicting a performance of the vehicle operating within or beyond the limitation based on the data, generating, by the vehicle during the operation of the vehicle, a new plan by modifying the limitation based on the performance, and determining, based on the new plan, one or more behaviors of the vehicle during the operation of the vehicle.

Example 18 provides the computer system of example 17, where the data includes sensor data captured by one or more sensors of the vehicle or another vehicle that operates in an environment where the vehicle performs the operation, data indicating a preference of a user of the online system who receives a service provided by the vehicle through the operation of the vehicle, or data indicating a capability of one or more components of the vehicle.

Example 19 provides the computer system of example 17, where modifying the limitation based on the performance includes determining that there is a safety risk to operate within the limitation; and modifying the limitation to reduce the safety risk.

Example 20 provides the computer system of example 17, where modifying the limitation based on the performance includes determining that there is no safety risk to operate beyond the limitation; and extending the limitation.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving, by a vehicle from an online system, a plan for an operation of the vehicle, the plan comprising a limitation on the operation of the vehicle, the plan generated before the operation of the vehicle;
obtaining, by the vehicle during the operation of the vehicle, data associated with the operation of the vehicle;
predicting a performance of the vehicle operating within or beyond the limitation based on the data;
generating, by the vehicle during the operation of the vehicle, a new plan by modifying the limitation based on the performance; and
determining, based on the new plan, one or more behaviors of the vehicle during the operation of the vehicle.

2. The method of claim 1, wherein the data comprises sensor data captured by one or more sensors of the vehicle or another vehicle that operates in an environment where the vehicle performs the operation.

3. The method of claim 1, wherein the operation of the vehicle is for providing a service to a user of the online system, and the data comprises data indicating a preference of the user.

4. The method of claim 1, wherein the data comprises data indicating a capability of one or more components of the vehicle.

5. The method of claim 1, wherein modifying the limitation based on the performance comprises:
determining that there is a safety risk to operate within the limitation; and
modifying the limitation to reduce the safety risk.

6. The method of claim 5, wherein the data comprises data indicating a condition of an environment in which the vehicle performs the operation, and determining that there is a safety risk to operate within the limitation comprises:
determining that there is a safety risk to operate within the limitation under the condition.

7. The method of claim 1, wherein modifying the limitation based on the performance comprises:
determining that there is no safety risk to operate beyond the limitation; and
extending the limitation.

8. The method of claim 1, wherein predicting the performance of the vehicle operating within or beyond the limitation based on the data comprises:
inputting the data into a trained model, the trained model outputting a prediction of the performance of the vehicle.

9. The method of claim 1, wherein the data comprises data indicating a condition of an environment in which the vehicle performs the operation, and predicting the performance of the vehicle operating within or beyond the limitation based on the data comprises:
predicting a safety risk of the vehicle operating within or beyond the limitation based on a performance of the vehicle in a previous operation under the condition.

10. The method of claim 1, wherein the limitation is a limitation on an attribute of the vehicle, a movement of the vehicle, an environment where the vehicle performs at least part of the operation, or a time when the vehicle performs at least part of the operation.

11. One or more non-transitory computer-readable media storing instructions executable to perform operations, the operations comprising:
receiving, by a vehicle from an online system, a plan for an operation of the vehicle, the plan comprising a limitation on the operation of the vehicle, the plan generated by the online system based on first data before the operation of the vehicle;
obtaining, by the vehicle during the operation of the vehicle, data associated with the operation of the vehicle, the data different from the first data;
predicting a performance of the vehicle operating within or beyond the limitation based on the data;
generating, by the vehicle during the operation of the vehicle, a new plan by modifying the limitation based on the performance; and
determining, based on the new plan, one or more behaviors of the vehicle during the operation of the vehicle.

12. The one or more non-transitory computer-readable media of claim 11, wherein the data comprises sensor data captured by one or more sensors of the vehicle or another vehicle that operates in an environment where the vehicle performs the operation.

13. The one or more non-transitory computer-readable media of claim 11, wherein the operation of the vehicle is for providing a service to a user of the online system, and the data comprises data indicating a preference of the user.

14. The one or more non-transitory computer-readable media of claim 11, wherein the data comprises data indicating a capability of one or more components of the vehicle.

15. The one or more non-transitory computer-readable media of claim 11, wherein modifying the limitation based on the performance comprises:
determining that there is a safety risk to operate within the limitation; and
modifying the limitation to reduce the safety risk.

16. The one or more non-transitory computer-readable media of claim 11, wherein modifying the limitation based on the performance comprises:
determining that there is no safety risk to operate beyond the limitation; and
extending the limitation.

17. A computer system, comprising:
a computer processor for executing computer program instructions; and
one or more non-transitory computer-readable media storing computer program instructions executable by the computer processor to perform operations comprising:
receiving, by a vehicle from an online system, a plan for an operation of the vehicle, the plan comprising a limitation on the operation of the vehicle, the plan generated by the online system based on first data before the operation of the vehicle,
obtaining, by the vehicle during the operation of the vehicle, data associated with the operation of the vehicle, the data different from the first data,
predicting a performance of the vehicle operating within or beyond the limitation based on the data,
generating, by the vehicle during the operation of the vehicle, a new plan by modifying the limitation based on the performance, and
determining, based on the new plan, one or more behaviors of the vehicle during the operation of the vehicle.

18. The computer system of claim 17, wherein the data comprises sensor data captured by one or more sensors of the vehicle or another vehicle that operates in an environment where the vehicle performs the operation, data indicating a preference of a user of the online system who receives a service provided by the vehicle through the operation of the vehicle, or data indicating a capability of one or more components of the vehicle.

19. The computer system of claim 17, wherein modifying the limitation based on the performance comprises:
determining that there is a safety risk to operate within the limitation; and
modifying the limitation to reduce the safety risk.

20. The computer system of claim 17, wherein modifying the limitation based on the performance comprises:
determining that there is no safety risk to operate beyond the limitation; and
extending the limitation.
